(19) United States
(12) Patent Application Publication
(10) Pub. No.: US 2009/0006822 A1
(43) Pub. Date: Jan. 1, 2009

(54) Device and Method for Adding and Subtracting Two Variables and a Constant

(75) Inventors: Evgeni Ginzburg, Petah Tikva (IL); Adi Kazt, Ramat Gan (IL)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: Freescale Semiconductor , Inc., Austin, TX (US)

(21) Appl. No.: 12/162,174

(22) PCT Filed: Jan. 27, 2006
(86) PCT No.: PCT/IB2006/050308

§ 371 Date: Jul. 25, 2008

(51) Int. Cl. G06F 9/302

(52) U.S. Cl. 712/221; 712/E09.017

(57) ABSTRACT

A method device and a method. The method includes fetching an instruction, decoding an instruction that includes an instruction type field, a first variable field, a second variable field, a result field and a constant field; selecting an operation out of addition operation, a subtraction operation and another type of operation, in response to the content of the instruction type field; determining, in response to the value of the constant field, whether the result of the selected operation is responsive to the first and second variables or is responsive to the first variable, the second variable and the constant; and executing the selected operation, during a single instruction execution cycle, to provide the result.

### FIELD OF THE INVENTION

The present invention relates to a device and a method for adding and subtracting two variables and a constant.

### BACKGROUND OF THE INVENTION

Modern processors are required to execute complex tasks at very high speeds. The introduction of pipelined processor architectures improves the performances of modern processors but also introduced some problems. In a pipelined architecture an execution of an instruction is split to multiple stages. The PowerPC™ processors family of Freescale™ Inc. is an example of pipelined processors.

Various communication integrated circuits transfer data. A data transfer is usually characterized by multiple parameters, including but not limited to a destination address, source address, data chunk size and a data block size. A data chunk is transferred during a single data transfer operation. The data transfer operation can be implemented by a direct memory access controller, but this is not necessarily so. A data block can include multiple data chunks. Accordingly, in order to transfer a data block multiple data transfer operations are required.

A data block transfer sequence includes determining the aggregate size of data chunks that were already transferred and the aggregate size of residual data chunks—the aggregate size of data chunks that should be transferred in order to complete the transfer of the data block.

In some communication integrated circuits zero represents a transfer of one byte. Thus, a certain number (Z) of digits can represent 2^{Z}-sized data entities. This corresponds to the usage of binary values to represent various data chunks and blocks.

This representation complicates the calculation of the aggregate size of data that was transferred (T(n)) during a data block transfer sequence. This also complicates the calculation of the aggregate size of data that should be transferred (R(n)) in order to complete a transfer of a data block.

Assuming, for example, that the size of each data chunk is (S+1) bytes. The data chunk size is represented by a variable that has a value of S. This is an example of a shifted-value size in which the shift is one. It is noted that other shifts (difference between value of variable and the size it represents) can be introduced.

After a data block is transferred both T(n) (and R(n)) should be updated by incrementing (or decrementing) the size of the last transferred data chunk to (or from) the previous value of T(n) (and R(n)). Assuming that T(n−1) is aggregate size of data that was transferred before that last data chunk was transferred and that R(n−1) is the aggregate size of data that should have been be transferred before that last data chunk was transferred then the following equations illustrate the update process: T(n)=T(n−1)+(S+1)=T(n−1)+S+1, and R(n)=R(n−1)−(S+1)=R(n−1)−S−1. Each of these updates requires two instructions, thus greatly reducing the throughput of the communication integrated circuit.

The PowerPC™ had an ADDE instruction and an SUBFE instruction in which a certain bit within one of the control registers of the PowerPC™ processor was added to the sum of two numbers. This instruction had to follow another instruction in which the number of that certain bit was set, thus two instructions were required for performing the addition or subtraction operations.

U.S. Pat. No. 5,854,920 of Lucas et al., illustrates a method for adjusting the range of a data processor instruction field. The range adjustment does not require instruction field modification operation or decoding. Immediate add instruction and subtract immediate operations can be implemented by controlling a value of a carry in/borrow bit of a full adder.

There is a need to provide an efficient method and device for adding and subtracting two variables and a constant.

### SUMMARY OF THE PRESENT INVENTION

A method and device for adding and subtracting two variables and a constant, as described in the accompanying claims.

### BRIEF DESCRIPTION OF THE DRAWINGS

The present invention will be understood and appreciated more fully from the following detailed description taken in conjunction with the drawings in which:

FIG. 1 is a schematic illustration of a device according to an embodiment of the invention;

FIG. 2 illustrates some registers that belong to a register file according to an embodiment of the invention;

FIG. 3 illustrates a subtraction instruction according to an embodiment of the invention;

FIG. 4 illustrates an addition instruction according to an embodiment of the invention; and

FIG. 5 illustrates a method for adding two variables and a constant, according to an embodiment of the invention.

### DETAILED DESCRIPTION OF PREFERRED EMBODIMENTS

The following description refers to methods and systems for adding and subtracting two variables and a constant.

The addition of two variables and a constant is implemented by executing a single instruction.

The subtraction of a constant and a first variable from another variable is implemented by executing a single instruction.

Conveniently, a device is provided. The device includes: (i) a fetch unit that is adapted to fetch an instruction, (ii) an issue unit that is adapted to decode an instruction that may include an instruction type field, a first variable field, a second variable field, a result field and a constant field, and (iii) an execute unit that is adapted to: (a) select an operation out of addition operation, a subtraction operation and another type of operation, in response to the content of the instruction type field, (b) to determine, in response to the value of the constant field, whether the result of the selected operation is responsive to the first and second variables or is responsive to the first variable, the second variable and the constant; and (c) to execute the selected operation, during a single instruction execution cycle, such as to provide the result. The result then can be stored in a register or in another memory unit.

Conveniently, the execute unit is adapted to add the first variable, the second variable and the constant to provide the result. Conveniently, the execute unit is adapted to subtract the constant and the second variable from the first variable to provide the result.

Conveniently, the constant equals one. Assuming that the first variable is denoted X and the second variable is denoted Y then the device is able to calculate either X+Y+1 or X−Y−1 within one instruction cycle.

According to an embodiment of the invention the device further includes a data manipulation circuit that is adapted to manipulate the result in order to provide a manipulated result. Conveniently, the device is further adapted to update at least one status flag in response to the value of the result.

According to an embodiment of the invention the first variable is a size of a data block, the second variable is a shifted-value size of a data chunk and the execute unit is adapted to calculate a result that reflects a size of data to be transferred in order to complete a transfer of a data block. A shifted-value size indicates that the value of the second variable differs from the actual size of the data chunk. The difference conveniently equals a constant.

According to an embodiment of the invention the first variable is a size of a data block, the second variable is a shifted-value size of a data chunk and the execute unit is adapted to calculate a result that reflects a size of data that was transmitted during one or more data chunk transfer operations.

Conveniently, the issue unit is adapted to generate an addition/subtraction indication signal and a constant discard/respond signal. The execute unit is responsive to the addition/subtraction indication signal and to the constant discard/respond signal.

Conveniently, the execute unit includes an adding/subtracting unit that includes: (i) a first XOR gate that is adapted to perform a XOR operation on the second variable and on the a addition/subtraction indication signal to provide a first intermediate result; (ii) a second XOR gate, adapted to perform a XOR operation on the a addition/subtraction indication signal and on the a constant discard/respond signal to provide a second intermediate result; and (iii) a full adder, adapted to add the first variable, the first intermediate result and the second intermediate result to provide the result.

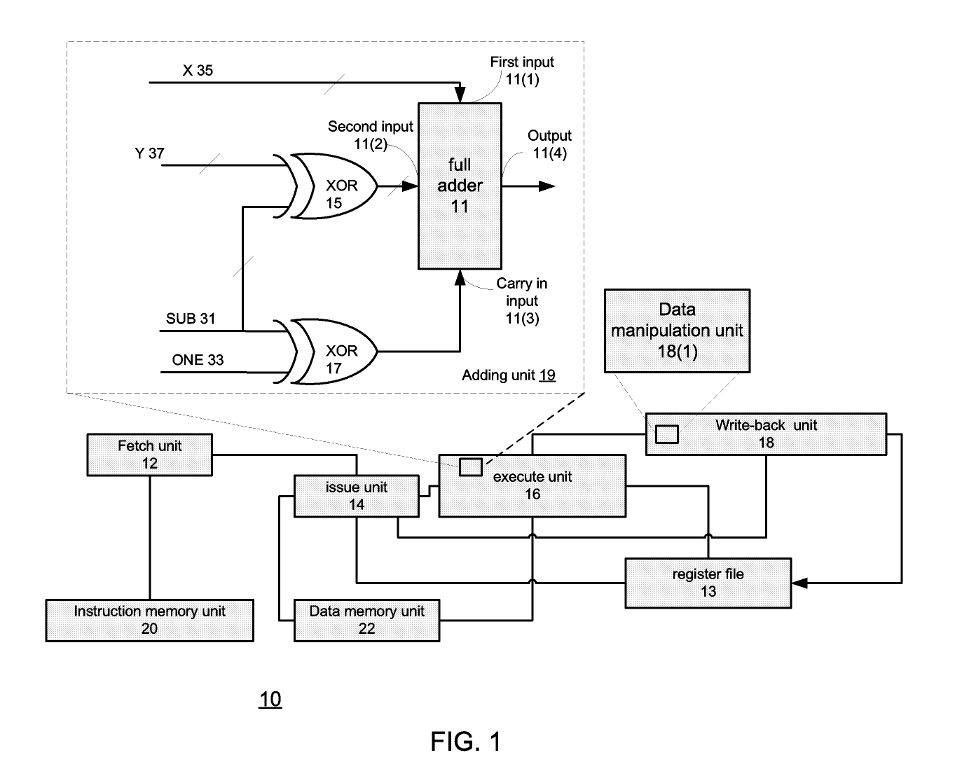

FIG. 1 illustrates device 10, according to an embodiment of the invention. Device 10 can be an integrated circuit, multiple integrated circuits, a mobile phone, personal data accessory, media player, computer, and the like. Those of skill in the art will appreciate that device 100 can include many components and units that are not illustrated in FIG. 1, as well as include fewer components or other components than those that are illustrated in FIG. 1.

Device 10 includes a fetch unit 12, an issue unit 14, an execute unit 16, a write back unit 18, a register file 13, an instruction memory unit 20 and a data memory unit 22. Units 12, 14, 16 and 18 form a pipelined processor. The pipelined processor is connected to the instruction memory unit 20 and to the data memory unit 22. The pipelined processor fetches instructions from the instruction memory unit 20 and fetches data from the data memory unit 22. It is noted that the issue unit 14 is also referred to as a decode unit.

The fetch unit 12 is connected to the instruction memory unit 20 and to the issue unit 14. The issue unit 14 is also connected to the data memory unit 22, to the register file 13, to the write back unit 18 and to the execute unit 16. The execute unit 16 is also connected to the data memory unit 22, the register file 13 and to the write back unit 18.

The write back unit 18 includes a data manipulation unit 18(1) that is able to perform bit swat operations, byte swap operations, word swap operations, long word swap operations, shift to the right operations and shift to the left operations. A bit swap operation includes inverting the order of bits within a larger entity such as byte, word or long word. A byte swap operation reverses the order of bytes within a larger entity.

The execute unit 16 includes an adding/subtracting unit 19 that is able to perform additions (or subtractions) of two variables and a constant (such as one) in one instruction cycle.

The adding/subtracting unit 19 is able to add or subtract two N-bit variables. N is a positive integer. N can be eight, sixteen, thirty two and the like.

For simplicity of explanation FIG. 1 illustrates a single N-bit full adder 11 and a single N-bit XOR gate 15. It is noted that multiple components can be used in order to perform N XOR gates operations as well as addition (or subtractions) of two N-bit variables. It is noted that by having multiple address, the provision of a constant that differs from one can be greatly simplified. It is further noted that each of the first XOR gate 15 and the second XOR gate 17 operates as a conditional inverter and that it can be replaced by any kind of conditional inverter. Conditional inverters can be implemented by using other logic gates, by using combinational logic such as multiplexers and the like.

The adding/subtracting unit 19 includes a full adder 11, a first XOR gate 15 and a second XOR gate 17. The full adder 11 includes a first N-bit input 11(1) for receiving a first N-bit variable (denoted X) 35, a second N-bit input 11(2) for receiving a first intermediate result that can be a selectively inverted second N-bit variable (denoted Y), a carry in input 11(3), and a (N+1)-bit output 11(4).

The first XOR gate 15 receives the second variable as well as a control signal SUB 31 and outputs a first intermediate result (that can be Y or an inverted Y) to the second input 11(2) of full adder 11.

The second XOR gate 17 receives a SUB signal 31 and a ONE signal 33 applies a XOR operation of these signals and provides a second intermediate result to the carry-in input 11(3) of the full adder 11.

Accordingly, the functionality of the adding/subtracting unit 19 is controlled by an addition/subtraction indication signal such as SUB 31 and a constant discard/respond signal such as ONE 33. Both signals are provided by the issue unit 14.

TABLE 1 illustrates the relationship between the values of ONE signal 33 and SUB signal 31, the signals provided to inputs 11(2) and 11(3) of the full adder 11 and the signal outputted from output 11(4) of full adder 11.

| | | Input | Input | |
|---|---|---|---|---|
| ONE signal | SUB signal | 11 (2) | 11 (3) | Result |
| 0 | 0 | Y | No carry | X + Y |
| | | | in | |
| 0 | 1 | Inverted Y | Carry in | X − Y |
| 1 | 0 | Y | Carry in | X + Y + 1 |
| 1 | 1 | Inverted Y | On carry | X − Y − 1 |
| | | | in | |

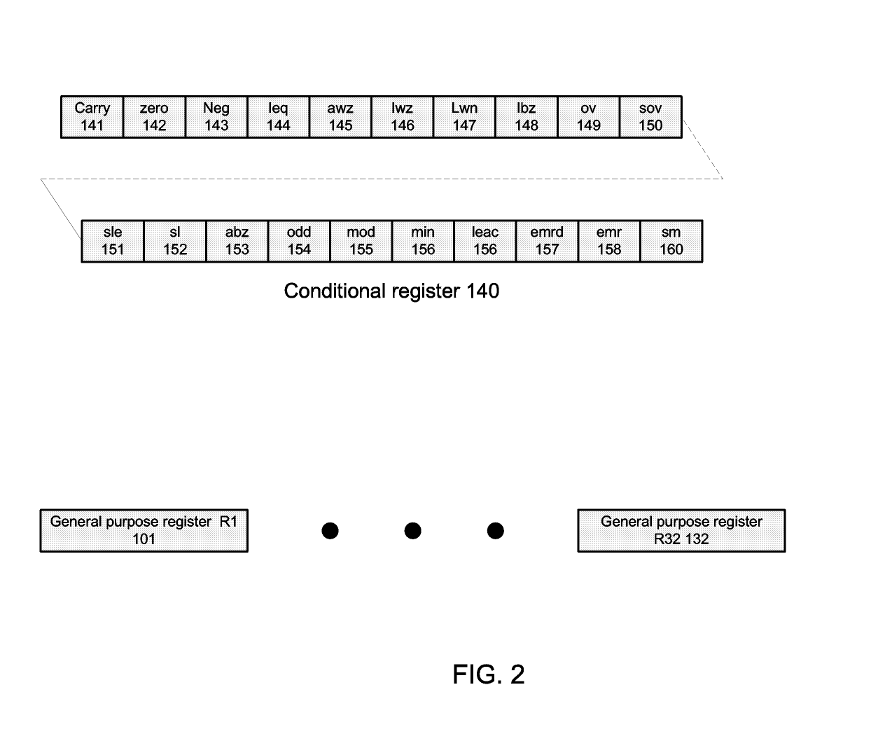

FIG. 2 illustrates some registers that belong to the register file 13 according to an embodiment of the invention.

Register file 13 includes thirty-two general purpose registers R1-R32 101-132, and various control and status register such as a conditional register CR 140. The conditional register 140 includes the following flags: carry flag (carry”) 141, zero flag (“zero”) 142, negative result flag (“neg”) 143, result less equal flag (“leq”) 144, result word zero flag (“awz”) 145, low word zero flag (“lwz”) 146, lower word negative flag (“lwn”) 147, lower byte zero flag (“lbz”) 148, overflow flag (“ov”) 149, summary overflow flag (“sov”) 150, signed less equal flag (“sle”) 151, signed less flag (“sl”) 152, result byte zero flag (“abz”) 153, result odd flag (“odd”) 154, modulo flag (“mod”) 155, minimum flag (“min”) 156, little Endian address correction flag (“leac”) 157, emergency derivative flag (“emrd”) 158, emergency request flag (“emr”) 159 and semaphore flag (“sm”) 160.

It is noted that various flags, such as flags 155, 157, 158, 159 and 160 are not affected by either an addition instruction 50 or by a subtraction instruction 40. The modulo flag 155 indicates if a modulo occurred during an address operation. The little Endian address correction flag 157 indicates if little Endian address correction is required. The emergency derivative flag 158 and emergency request flag 159 relate to an emergency mode operation of the pipelined processor. The semaphore flag 160 is set or reset during load instructions.

The signed less equal flag 151 and the signed less flag 152 can be affected by a subtraction instruction 40. The signed less equal flag 151 is set if signed variable X is smaller than signed variable Y or equal to Y. The signed less flag 152 is set if signed variable X is smaller than signed variable Y.

The carry flag 141 is set if a carry was generated during the execution of an instruction. The zero flag 142 is set if the result is zero. The negative result flag 143 is set if the result is negative. The result less equal flag 144 is set if all the bits of the result are zero or if the most significant bit of the result is set. The result word zero flag 145 is set if all sixteen upper or lower bits of the result are zero. The low word zero flag 146 is set if the sixteen lower bits of the result are zero. The lower word negative flag 147 is set if the sixteenth bit of the result is set. The lower byte zero flag 148 is set if all lower bits of the result are zero. The overflow flag 149 is set if the result cannot be representative as a signed integer less that a predefined upper threshold or great than a predefined lower threshold. The summary overflow flag 150 is set if a overflow occurred and the flag remains set until being cleared by a dedicated instruction. The result byte zero flag 153 is set if any byte in the result equals zero. The result odd flag 154 is set if the result is odd. The minimum flag 156 is set of the result, before being swapped, equals 0x80000000.

These flags are usually utilized in conditional branches.

According to an embodiment of the invention there are thirty two additional shadow general purpose registers that are used in dedicated operational modes. It is noted that the number of registers as well as the size of the registers can be altered without departing from the scope of the invention.

Those of skill in the art will appreciate that conditional register CR 140 can include other flags, additional flags, fewer flags and the like.

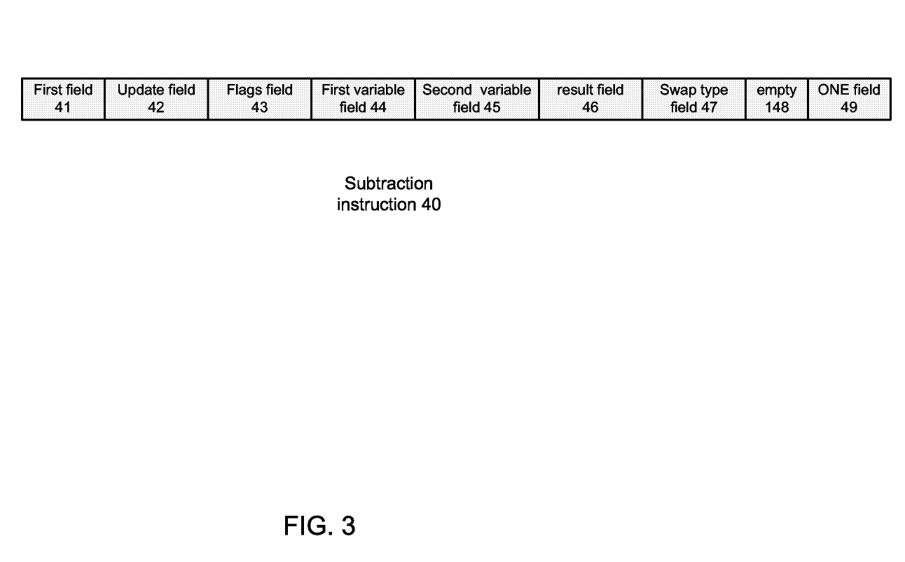

FIG. 3 illustrates a subtraction instruction 40 according to an embodiment of the invention.

The following description uses terms such as RA, RB and RC. Conveniently these are general-purpose registers out of registers R1-R32 101-132. Conditional register 140 can also be used as a source or result register.

Subtraction instruction 40 includes a first field 41, an optional update field 42, an optional flags field 43, a first variable field 44, a second variable field 45, a result field 46, a swap type field 47, two empty bits 48 and a ONE field 48.

The first field 41 includes a code that indicates that instruction 40 is a subtraction instruction. The inventors used the following code ‘110111000’ but other codes can be used. Signal SUB 31 is asserted when subtraction instruction 40 is decoded.

The update field 42 indicates whether to write the result at a general purpose result register or at the conditional register CR 140. According to an embodiment of the invention if the update field 42 is set and the value of the result field 46 is ‘1111’ then the result is written to the conditional register CR 140, else the result is written to a general purpose result register RC.

The optional flags field 43 indicates whether to update the content of the conditional register 140 in response to the result. Accordingly, if the flags field 43 is set the processor determines the flags in conditional register 140 to indicate, for example, if the result equals zero, if the result is negative, if the calculation of the result generated a carry and the like.

The first variable field 44 can store X 35 or indicate where X is stored. The inventors stored X in a first general purpose register RA and the first variable field 44 stored the address of RA.

The second variable field 45 can store Y 37 or indicate where Y is stored. The inventors stored Y in a second general purpose register RB and the second variable field 45 stored the address of RB.

The result field 46 can store the result of the subtraction operation or indicate where the result is stored. The inventors stored the result in a third general purpose register RC and the result field 46 stored the address of RC.

The inventors used thirty two general purpose registers and the length of each of the first variable field 44, second variable field 45 and result field 46 was five bits. It is further notes that each of these general purpose registers can store the address of an entry that actually stores X, Y or the result. This the invention can utilize direct or indirect addressing schemes.

The swap type field 47 indicates which type of swap operation (if any) to perform on the result.

The ONE field 48 indicates whether to perform a X-Y operation or a X−Y−1 operation.

The Assemble syntax of subtraction instruction 40 is: SUB{swap_option .n .f .ONE), whereas swap option is associated with the swap type field 47, the .n is associated with the optional update field 42, the .f is associated with the optional flags field 43, and the ONE is associated with the ONE field 48.

TABLE 2 illustrates various Assembler formats of subtraction instruction 40.

TABLE 2

| | |
|---|---|
| SUB RC, RA, RB | Subtract Y from X and store the result |
| | in RC |
| SUB.bytsw .f .ONE | Subtract Y and 1 from X, apply a byte |
| RC, RA, RB | swap operation, update flags in CR and |
| | store the swapped result in RC |
| SUB .n ONE RC, | Subtract Y and 1 from X, store the |
| RA, RB | result at CR if RC = 1111, else store |
| | result at RC |
| SUB CR, RA, RB | Subtract Y from X and store the result |
| | in CR |

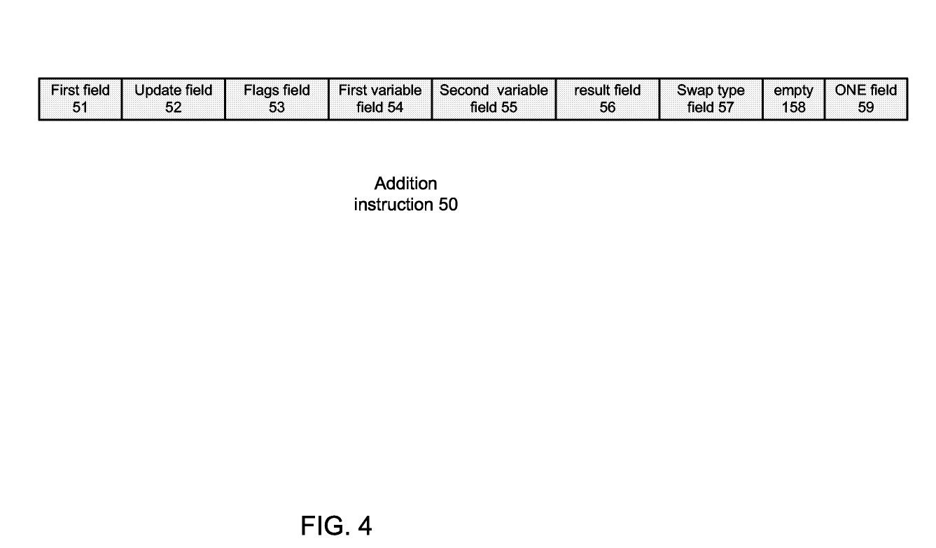

FIG. 4 illustrates an addition instruction 50 according to an embodiment of the invention.

Addition instruction 50 includes a first field 51, an optional update field 52, an optional flags field 53, a first variable field 54, a second variable field 55, a result field 56, a swap type field 57, two empty bits 58 and a ONE field 58. The first field 51 includes a code that indicates that instruction 50 is an addition instruction. The inventors used the following code ‘110110000’ but other codes can be used. Signal SUB 31 is negated when addition instruction 50 is decoded.

The operational update field 52, the optional flags field 53, the first variable field 54, the second variable field 55, the result field 56, the swap type field 57 and the two empty bits 58 of the addition instruction 50 are analogues to the optional update field 42, the optional flags field 43, the first variable field 44, the second variable field 45, the result field 46, the swap type field 47 and the two empty bits 48 of the subtraction instruction 40.

If ONE field 58 indicates whether to perform a X+Y+1 operation or a X+Y operation.

The Assemble syntax of addition instruction 50 is: ADD{swap_option .n .f .ONE), whereas swap option is associated with the swap type field 57, the .n is associated with the optional update field 52, the .f is associated with the optional flags field 53, and the ONE is associated with the ONE field 58.

TABLE 3 illustrates various Assembler formats of addition instruction 50.

TABLE 3

| | |
|---|---|
| ADD RC, RA, RB | Add Y to X and store the result in RC |
| ADD.bytsw .f .ONE | Add Y to 1 and to X, apply a byte swap |
| RC, RA, RB | operation, update flags in CR and |
| | store the swapped result in RC |
| ADD .n ONE RC, | Add Y to 1 and to X, store the result |
| RA, RB | at CR if RC = 1111, else store result at |
| | RC |
| ADD CR, RA, RB | ADD Y to X and store the result in CR |

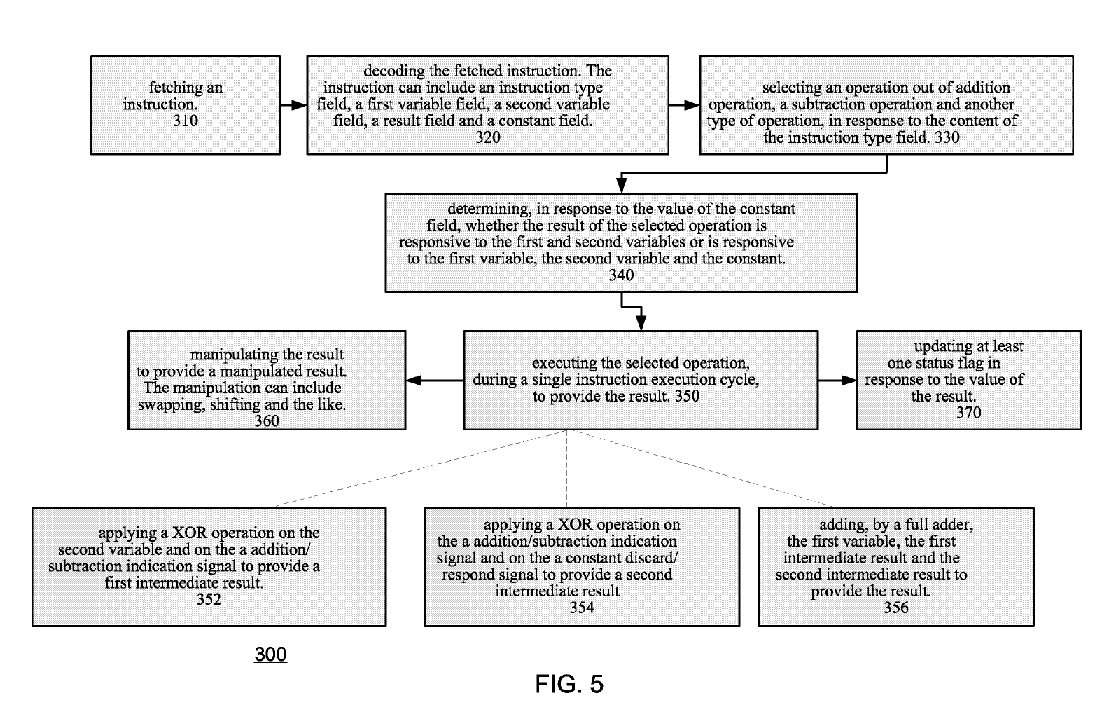

FIG. 5 illustrates a method 300 for adding two variable and a constant, according to an embodiment of the invention.

Method 300 starts by stage 310 of fetching an instruction.

Stage 310 is followed by stage 320 of decoding the fetched instruction. The instruction can include an instruction type field, a first variable field, a second variable field, a result field and a constant field. It is noted that the combination of first variable field, second variable field, result field and constant field appears in addition and subtraction instructions but does not necessarily appear in other types of instructions.

Conveniently, the decoding includes generating an addition/subtraction indication signal and a constant discard/respond signal, if the instruction is an addition or subtraction operation.

Stage 320 is followed by stage 330 of selecting an operation out of addition operation, a subtraction operation and another type of operation, in response to the content of the instruction type field.

Conveniently, stage 330 is responsive to the addition/subtraction indication.

It is noted that if the instruction is not an addition instruction or a subtraction instruction stage 330 can be followed by stages other than stage 340 and that if the instruction is another type of instruction the constant field may not exist.

Stage 340 includes determining, in response to the value of the constant field, whether the result of the selected operation is responsive to the first and second variables or is responsive to the first variable, the second variable and the constant.

Conveniently, stage 340 is responsive to the constant discard/respond signal Stage 340 is followed by stage 350 of executing the selected operation, during a single instruction execution cycle, to provide the result.

Conveniently, the single instruction execution cycle is the time period that an execution unit requires for executing a single instruction. After such a period lapses the execution unit can execute another instruction. The length (clock cycles) of such a cycle can vary, depending upon the structure of the execution cycle, its complexity and the like.

Conveniently, the constant equals one. Thus, method 300 can perform various operations such as X+Y+1, Z−Y−1, X+Y and X−Y.

Conveniently, the executing includes adding the first variable, the second variable and the constant to provide the result.

Conveniently, the executing includes subtracting the constant and the second variable from the first variable to provide the result.

Conveniently, the first variable is a size of a data block, the second variable is a shifted-value size of a data chunk and stage 350 of executing includes calculating a result that reflects a size of data to be transferred in order to complete a transfer of a data block.

According to an embodiment of the invention the first variable is a size of a data block, the second variable is a shifted-value size of a data chunk and stage 350 of executing includes calculating a result that reflects a size of data that was transmitted during one or more data chunk transfer operations.

Conveniently, stage 350 is followed by stages 460 and 370. Stage 360 includes manipulating the result to provide a manipulated result. The manipulation can include swapping, shifting and the like. Stage 370 includes updating at least one status flag in response to the value of the result.

Conveniently, the executing includes: stage 352 of applying a XOR operation on the second variable and on the a addition/subtraction indication signal to provide a first intermediate result; stage 354 of applying a XOR operation on the a addition/subtraction indication signal and on the a constant discard/respond signal to provide a second intermediate result; and stage 356 of adding, by a full adder, the first variable, the first intermediate result and the second intermediate result to provide the result.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

1. A method, comprising:
fetching an instruction;
decoding an instruction that comprises an instruction type field, a first variable field, a second variable field, a result field and a constant field;
selecting an operation out of addition operation, a subtraction operation and another type of operation, in response to the content of the instruction type field;
determining, in response to the value of the constant field, whether the result of the selected operation is responsive to the first and second variables or is responsive to the first variable, the second variable and the constant; and
executing the selected operation, during a single instruction execution cycle, to provide the result.

2. The method according to claim 1 wherein the constant equals one.

3. The method according to claim 1 wherein the executing comprises adding the first variable, the second variable and the constant to provide the result.

4. The method according to claim 1 wherein the executing comprises subtracting the constant and the second variable from the first variable to provide the result.

5. The method according to claim 1 wherein the executing if followed by manipulating the result to provide a manipulated result.

6. The method according to claim 1 further comprising updating at least one status flag in response to the value of the result.

7. The method according to claim 1 wherein the first variable is a size of a data block, the second variable is a shifted-value size of a data chunk and wherein the executing comprises calculating a result that reflects a size of data to be transferred in order to complete a transfer of a data block.

8. The method according to claim 1 wherein the first variable is a size of a data block, the second variable is a shifted-value size of a data chunk and wherein the executing comprises calculating a result that reflects a size of data that was transmitted during one or more data chunk transfer operations.

9. The method according to claim 1 wherein the decoding comprises:
generating an addition/subtraction indication signal and a constant discard/respond signal; and
wherein the selecting and the determining are responsive to the addition/subtraction indication signal and to the constant discard/respond signal.

10. The method according to claim 9 wherein the executing comprises:
applying a XOR operation on the second variable and on the a addition/subtraction indication signal to provide a first intermediate result;
applying a XOR operation on the a addition/subtraction indication signal and on the a constant discard/respond signal to provide a second intermediate result; and
adding, by a full adder, the first variable, the first intermediate result and the second intermediate result to provide the result.

11. A device, comprising:
a fetch unit adapted to fetch an instruction;
an issue unit adapted to decode an instruction that comprises an instruction type field, a first variable field, a second variable field, a result field and a constant field;
an execute unit, adapted to select an operation out of addition operation, a subtraction operation and another type of operation, in response to the content of the instruction type field, to determine, in response to the value of the constant field, whether the result of the selected operation is responsive to the first and second variables or is responsive to the first variable, the second variable and the constant; and to execute the selected operation, during a single instruction execution cycle, to provide the result.

12. The device according to claim 11 wherein the constant equals one.

13. The device according to claim 11 wherein the execute unit is adapted to add the first variable, the second variable and the constant to provide the result.

14. The device according to claim 11 wherein the execute unit is adapted to subtract the constant and the second variable from the first variable to provide the result.

15. The device according to claim 11 wherein the device further comprises a data manipulation circuit adapted to manipulate the result to provide a manipulated result.

16. The device according to claim 11 further adapted to update at least one status flag in response to the value of the result.

17. The device according to claim 11 wherein the first variable is a size of a data block, the second variable is a shifted-value size of a data chunk and wherein the execute unit is adapted to calculate a result that reflects a size of data to be transferred in order to complete a transfer of a data block.

18. The device according to claim 11 wherein the first variable is a size of a data block, the second variable is a shifted-value size of a data chunk and wherein the execute unit is adapted to calculate a result that reflects a size of data that was transmitted during one or more data chunk transfer operations.

19. The device according to claim 11 wherein the issue unit is adapted to generate a addition/subtraction indication signal and a constant discard/respond signal; and wherein the execute unit is responsive to the addition/subtraction indication signal and to the constant discard/respond signal.

20. The device according to claim 9 wherein the execute unit comprises:
an adding/subtracting unit that comprises a first XOR gate adapted to perform a XOR operation on the second variable and on the a addition/subtraction indication signal to provide a first intermediate result;
a second XOR gate, adapted to perform a XOR operation on the a addition/subtraction indication signal and on the a constant discard/respond signal to provide a second intermediate result; and
a full adder, adapted to add the first variable, the first intermediate result and the second intermediate result to provide the result.
